(19) United States
(12) Patent Application Publication
(10) Pub. No.: US 2009/0029141 A1
(43) Pub. Date: Jan. 29, 2009

(54) MAT-FACED GYPSUM BOARD AND METHOD OF MAKING THEREOF

(75) Inventors: Michael P. SHAKE, Johnsburg, IL (US); Qingxia LIU, Vernon Hills, IL (US); Salvatore C. IMMORDINO, Trevor, WI (US); Dick C. ENGBRECHT, Arlington Heights, IL (US); Donald L. ROELFS, West Burlington, IA (US); Christopher R. NELSON, Lindenhurst, IL (US); Wayne J. ROHRBAUGH, Dublin, OH (US); Joseph J. FEDORIS, Mediapolis, IA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: UNITED STATES GYPSUM COMPANY, Chicago, IL (US)

(21) Appl. No.: 12/176,200

(22) Filed: Jul. 18, 2008

Related U.S. Application Data
(60) Provisional application No. 60/951,400, filed on Jul. 23, 2007.

(51) Int. Cl. B32B 13/14; B28B 1/50

(52) U.S. Cl. 428/293.4; 156/44; 428/294.7

(57) ABSTRACT

A mat-faced gypsum board and method of making thereof is provided having a particulate matter applied on an inner surface of the facer mat and extending partially into the mat from the inner surface thereof. The particulate matter, which is preferably a hydratable powder such as calcium sulfate hemihydrate, minimizes and, preferably, prevents bleed through of a gypsum slurry during formation of the gypsum board.

### CROSS-REFERENCE TO RELATED APPLICATIONS

This patent application claims the benefit of U.S. Provisional Patent Application No. 60/951,400, filed Jul. 23, 2007, which is incorporated by reference.

### TECHNICAL FIELD

The field relates to gypsum boards and, in particular, mat-faced gypsum boards and methods of making thereof.

### BACKGROUND OF THE INVENTION

Wall board having a gypsum-based core reinforced on the outer major surfaces with a facing material or scrim is well-known in the art. These gypsum boards are commonly used to form interior or exterior walls, elevator shafts, stairwells, ceilings, and roof decks to suggest but a few examples. In some cases, paper facer sheets are used with the gypsum-based core. In other instances, a fibrous mat, such as a non-woven glass fiber mat, is used as the facing material. In particular, glass-mat faced gypsum boards are often used as part of an exterior insulation and finish system (EIFS system) as well other uses.

Manufacturing gypsum board using such fibrous mats can be challenging due to the tendency of the aqueous gypsum slurry to seep or bleed through the pores of the fibrous mat when the slurry is still in a liquid state. This bleed through problem is especially noticeable at the point where the slurry is first deposited onto the fibrous mat prior to the board forming head. Slurry bleed through can lead to unwanted gypsum on the outer surface of the fibrous mat and build-up of gypsum on rollers or other machine equipment. Gypsum build-up on rollers requires periodic machine shut down for cleaning because gypsum on rollers can transfer to the outer surface of the fibrous mat and/or lead to web tracking problems of the fibrous web into the forming head. Gypsum on the outer surface of the mat can decrease the adherence of a finish coat and present an unpleasing appearance for the consumer.

Various attempts at preventing or minimizing gypsum slurry bleed through have been suggested. For example, it has been proposed to modify the slurry viscosity through the use of viscosity-control agents in order to minimize the ability of the slurry to seep through the web. Other suggestions provide resins and other coatings to the outer surface of the web to block pores in the fibrous web to limit bleed through. Yet other attempts focus on modifying the characteristics of the fibrous web itself. For instance, one suggestion uses a fibrous web composed of glass fibers with a specific diameter between 10 and 15 microns and a specific basis weight greater than 1.85 lbs/100 ft² in combination with specific extrusion ratios. Other web modification proposals suggest using a fibrous mat composed of a blend of staple fibers and microfibers (average diameter of 1 micron or less) to block bleed through of the slurry. Yet other suggestions include increasing the thickness of the fibrous mat or altering the surface characteristics of the mat fibers to decrease their wetability. See, for example, U.S. Pat. Nos. 4,186,236; 4,388,366; 4,637,951; 4,681,798; 4,810,569 and 6,001,496 as well as U.S. Patent Application Publication No. 2007/0148430 A1 and European Patent Application No. EP 1 801 278 A1. These proposed solutions, however, may require extra processing steps, incorporate additional materials, vary slurry characteristics to undesired ranges, and/or specify the use of custom or non-standard fibrous mats. In many cases, the above suggested techniques to limit bleed through are undesired for various cost, technical, and other reasons.

Accordingly, there is a desire to provide a gypsum board and a method of making thereof having minimal and, preferably, no bleed through of the gypsum slurry during manufacture of the gypsum board.

### BRIEF SUMMARY OF THE INVENTION

In one aspect, the invention provides a method of forming a gypsum board, the method comprising providing a porous substrate having an inner surface, applying a particulate matter to the inner surface of the porous substrate forming a powder faced substrate, depositing an aqueous gypsum slurry to the inner surface of the powder faced substrate over at least a portion of the applied particulate matter forming a slurry coated substrate, wherein the particulate matter fills a portion of the pores in the porous substrate to hinder penetration of the gypsum slurry therethrough, and forming the slurry coated substrate into the gypsum board.

In another aspect, the invention provides a mat-faced gypsum board comprising a gypsum-based core, a fibrous mat having an inner surface facing at least one side of the gypsum-based core, and a hydrated particulate material on the inner surface of the fibrous mat and extending partially into the fibrous mat from the inner surface thereof, wherein the hydrated particulate material is supplied independent of the gypsum-based core.

A mat-faced gypsum board comprising a gypsum-based core, a fibrous mat having an inner surface facing at least one side of the gypsum-based core, and a hydrated particulate material on the inner surface of the fibrous mat and extending partially into the fibrous mat from the inner surface thereof, wherein the composition of the hydrated particulate material differs from the composition of the gypsum-based core.

These and other advantages of the present invention, as well as additional inventive features, will be apparent from the description of the invention provided herein.

### BRIEF DESCRIPTION OF THE SEVERAL VIEWS OF THE DRAWING(S)

FIG. 1 is a schematic view of an exemplary board conversion process to minimize bleed through of the gypsum slurry;

FIG. 2 is a schematic view of a dry particulate application system for use on the board conversion process of FIG. 1;

FIG. 3 is a perspective view of a slurry depositing station having dry particulate applied to a portion of the web;

FIG. 4 is a flowchart of an exemplary board forming process;

FIG. 5 is a SEM photograph of a commercially available glass fiber mat showing a cross-section thereof at 50× magnification prior to the application of a dry particulate to an inner surface of the mat;

FIG. 6 is a SEM photograph of a top view showing an inner surface of a commercially available glass fiber mat at 100× magnification prior to the application of a dry particulate to the inner surface of the mat;

FIG. 7 is a SEM photograph of the commercially available glass fiber mat of FIG. 5 showing the cross section at 50× magnification after application of a dry particulate to the inner surface thereof;

FIG. 8 is a SEM photograph of a top view showing the inner surface of the commercially available glass fiber mat of FIG. 6 at 100× magnification after the application of a dry particulate to the inner surface thereof, and

FIG. 9 is a photograph of mat faced gypsum boards made with and without a dry particulate applied to an inner face of the facer mat.

### DETAILED DESCRIPTION OF THE INVENTION

A mat-faced gypsum board and method of making thereof that minimizes and, preferably, prevents slurry bleed through of the mat is provided. By one approach, the method includes applying a dry particulate matter, such as a dry powder, to an inner surface of a porous substrate used to form the facer mat of the gypsum board (e.g., a fibrous mat). As used herein, “inner surface” refers to the surface of the porous substrate that a gypsum slurry is deposited on and further contacts the gypsum core of a finished gypsum board. Preferably, the dry particulate matter is applied just prior to depositing gypsum slurry to the substrate or mat. In one form, the dry particulate matter is a hydratable powder or particulate that penetrates into pores or interstices of the porous substrate and hydrates via excess water in the gypsum slurry. In other words, the particulate matter comprises a hydratable powder, and water from the aqueous gypsum slurry substantially hydrates the hydratable powder. The hydrated powder then sets in the pores or other interstices of the mat and hinders slurry penetration therethrough by blocking or hindering potential routes of the liquid slurry through the mat.

The formed mat-faced gypsum board includes a gypsum-based core having the fibrous mat face on at least one side thereof. The gypsum-based core optionally can comprise a second fibrous mat wherein the gypsum-based core is disposed between the first fibrous mat and the second fibrous mat. The second fibrous mat can be the same or different from the first fibrous mat. The fibrous mat includes a powder deposition of the particulate matter on the inner surface thereof at the interface between the gypsum core and mat. Preferably, the particulate matter extends partially into the fibrous mat from the inner surface so that the outer surface of the fibrous mat is essentially free of the particulate (e.g., no particulate on the outer surface visible to the unaided eye). While the powder or particulate can include similar components as found in the gypsum core, the particulate matter is applied independent from and is not supplied or otherwise transferred from the gypsum core to the fibrous mat. In other words, the particulate matter can have a composition that is different from that of the gypsum slurry. That is, a typical construction of mat-faced gypsum boards includes some mechanical locking of the fibrous mat to the gypsum core by the core materials penetrating the mat. Herein, the particulate matter is separate from the core materials as it is preferably pre-applied to the fibrous mat prior to the application of the core slurry. It will be appreciated, however, that in some cases there may be blending of the particulate matter and the penetrated core materials after board formation. If the dry particulate matter includes the preferred hydratable material, then the powder when hydrated or set can additionally help secure the fibrous mat to the gypsum core by forming additional mechanical locking with the gypsum core similar to how the fibrous mat locks to the core by penetration into the gypsum core.

As mentioned above, the dry particulate matter preferably comprises, consists essentially of, or consists of a hydratable powder such as a hydratable inorganic powder. For example, the dry particulate matter may include (comprise, consist essentially of, or consist of) gypsum-based particulates (e.g., water-soluble calcium sulfate anhydrite, calcium sulfate α-hemihydrate, calcium sulfate β-hemihydrate, natural, synthetic or chemically modified calcium sulfate hemihydrates, calcium sulfate dihydrate (“gypsum,” “set gypsum,” or “hydrated gypsum”), and mixtures thereof), expanding clays (e.g., montmorillonite, attapuligite and the like), calcium carbonate, mixtures thereof, and the like. In a particularly preferred form, the dry particulate matter includes (comprises, consists essentially of, or consists of) calcium sulfate hemihydrate (stucco) in a powdered form, which hydrates (e.g., partially, substantially, or completely) into calcium sulfate dihydrate (gypsum) using the excess water of the gypsum slurry. Preferably, the particulate material has an average size of about 10 to about 50 microns (most preferably about 10 to about 40 microns, about 10 to about 25 microns, or about 10 to about 15 microns) and is applied at a rate of about 10 to about 40 lbs/1000 ft² to the inside of the fibrous web. For example, the particulate material can be applied at a rate of about 10 lbs/1000 ft² or more, about 15 lbs/1000 ft² or more, about 20 lbs/1000 ft² or more, or about 25 lbs/1000 ft² or more. Typically, the particulate matter will be applied at a rate of about 40 lbs/1000 ft² or less, such as about 35 lbs/1000 ft² or less, or even about 30 lbs/1000 ft² or less. By way of further illustration, the particulate material can be applied at a rate of about 10 to about 20 lbs/1000 ft², about 10 to about 30 lbs/1000 ft², about 20 to about 30 lbs/1000 ft², about 20 to about 40 lbs/1000 ft², or about 30 to about 40 lbs/1000 ft². In another aspect of the embodiment, the particulate material can be applied at a rate of about 10 lbs/1000 ft², about 15 lbs/1000 ft², or about 20 lbs/1000 ft². However, other application rates and powder sizes and may also be used depending on the particular fibrous mat, viscosity of slurry, and other factors.

In another aspect, the dry particulate matter may further include other fillers or additives to provide additional functional enhancements to the gypsum board. For example, the dry particulate material may include an amount of dry polymer or resin, which may provide a moisture barrier on the inside surface of the mat. Such additives may include powdered redispersible polymers or resins such as acrylic powders, polyvinyl alcohol, vinyl acetate, polyethylene glycol, polyvinyl chloride, copolymers of such resins (i.e., PVA/PVC copolymers), mixtures thereof, and the like. By one approach, the dry particulate matter may include about 1 to about 30 weight percent of such redispersible polymers or resins. Once applied to the mat, these polymers or resins will redisperse using water from the aqueous gypsum slurry to generally form resin deposits or other barrier on the inner surface of the mat and/or extend partially through the mat from the inner surface thereof. It is expected that any resins or polymers will not extend through the mat to the outer surface thereof. It has been discovered that such resins generally improve the trowelability of EIFS or other direct applied finish system materials to the gypsum board, which enables an end user to apply a more uniform surface finish to the outer surface of the board. While not wishing to be limited by theory, it is believed that the redispersed resin particulate helps a surface finish retain moisture so that it can be spread more evenly across the board rather than the gypsum core absorbing moisture from the outer finish during application.

The fibrous mat can comprise any suitable type of polymer or mineral fiber, or combination thereof. Non-limiting examples of suitable fibers include glass fibers, polyamide fibers, polyaramide fibers, polypropylene fibers, polyester fibers (e.g., polyethylene teraphthalate (PET)), polyvinyl alcohol (PVOH), polyvinyl acetate (PVAc), cellulosic fibers (e.g., cotton, rayon, etc.), and the like, as well as combinations thereof. The fibrous mat can be woven or non-woven; however, non-woven mats are preferred. Non-woven mats comprise fibers bound together by a binder. The binder can be any binder typically used in the mat industry. Suitable binders include, without limitation, urea formaldehyde, melamine formaldehyde, stearated melamine formaldehyde, polyester, acrylics, polyvinyl acetate, urea formaldehyde or melamine formaldehyde modified or blended with polyvinyl acetate or acrylic, styrene acrylic polymers, and the like, as well as combinations thereof. Suitable fibrous mats include commercially available mats used as facing materials for cementitious articles.

In one embodiment, the porous fibrous mat is a glass fiber mat formed from chopped or continuous glass fibers having an average diameter of about 5 to about 20 microns, such as about 10 to about 20 microns or even about 11 to about 16 microns and a basis weight of about 20 lbs/1000 ft² or greater. The porous fibrous mat also can comprise microfibers having a diameter, for instance, of about 2-8 microns or 4-6 microns. The fibrous mat also can comprise fibers having different diameters. For example, the glass fiber mat can comprise about 70 to about 90 percent glass fibers having a diameter of about 10 to about 20 microns and about 10 to about 30 percent glass fibers having a smaller diameter of about 2 to about 15 microns with a basis weight of about 20 lbs/1000 ft² or greater. In another embodiment, the fibrous mat can comprise about 70 to about 90 percent glass fibers having a diameter of about 14 microns or greater, or 15 microns or greater (e.g., about 14 to about 16 microns) and about 10 to about 30 percent glass microfibers having a diameter of about 4 to about 6 microns with a basis weight of about 20 lbs/1000 ft² or greater. The fibers can have any suitable length. For instance, the microfibers can be of varying lengths. The other fibers typically will have a length of about 1-inch or less (e.g., about ⅜-inch to 1-inch, or about ½-inch to about ¾-inch). By way of further illustration, one such glass fiber mat is formed from about 80 percent fibers having about 16 micron diameter (about ½ inch length) and about 20 percent of the fibers having about II micron diameter (about ¼ inch length) with a basis weight of about 22 lbs/1000 ft². Another suitable glass fiber mat is formed from about 90 percent fibers having about 16 micron diameter (¾ inch length) and about 10 percent of the fibers having about 4 to about 6 micron diameter (various lengths) with a basis weight of about 22 lbs/1000 ft².

The mat is preferably formed using a thermosetting resin to bind the glass fibers into a non-woven web. By one approach, the thermosetting resin may be an acrylic resin, such as a blend of melamine formaldehyde and other acrylic resins. The mat can comprise any suitable amount of binder, such as about 5-40% by weight, about 10-30% by weight, or about 20-30% by weight. The above described fibrous mat is but one example of a suitable mat that can be employed herein. It will be appreciated that other porous and fibrous mats having various compositions may also be employed using the methods described herein.

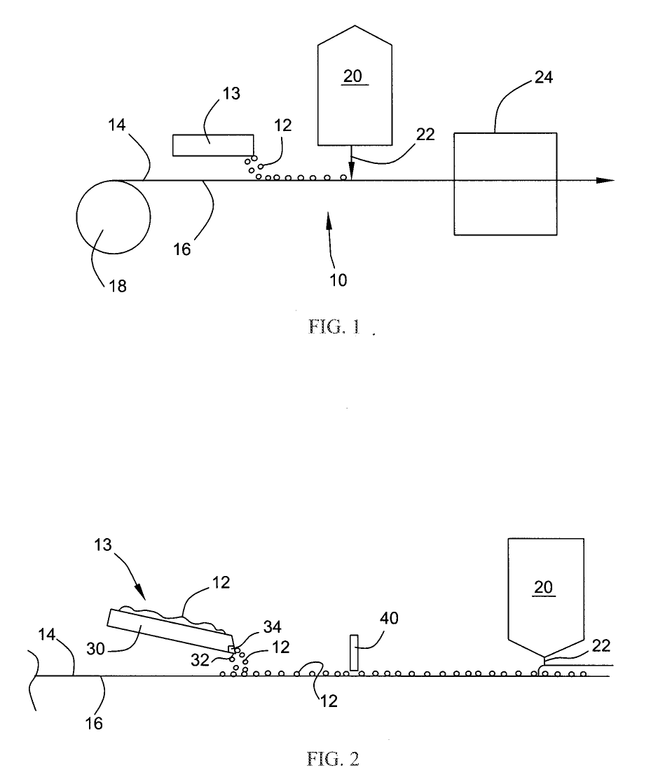

The dry particulate matter may be deposited or applied to the web (i.e., surface of the porous substrate or fibrous mat) using any known application method to disperse a dry or solid particulate to a moving web. Turning to FIGS. 1 through 4, one example of an application system (10) is illustrated where a dry particulate matter (12) is deposited from an applicator, feeder, or hopper (13) to an inner surface (14) of a fibrous mat (16) in-line between a web unwind station (18) and the slurry mixing tank (20) of a gypsum board conversion line. In this manner, the dry particulate matter (12) is applied to the web just prior to location where the slurry is deposited (22) onto the web (16) before the board forming head (24). The dry particulate matter is then effective to minimize and, preferably, prevent slurry bleed through between the slurry depositing site (22) and the board forming head (24).

By one approach, the applicator (13) may include a table, tray, hopper, feeder, or other container (30) that holds an excess amount of the particulate (12) thereon. Suitable feeders, including vibratory and rotary feeders, are commercially available. The applicator (13) can be configured to apply the particulate (12) to the web via the tray (30) being inclined a predetermined amount to permit sifting or free dropping of an amount of the particulate (12) onto the inner surface (14) of the fibrous web (16) as it is passed underneath the tray (30). For example, as shown in FIG. 2, the table (30) is inclined and vibrated or shaken to permit the particulate matter to drop or fall off a leading edge (32) thereof. The leading edge (32) may include a metering device (34), such as knurled rotating wheel, to provide a more controlled application of the particulate matter. It will be appreciated that other application methods may be employed to disperse the particulate matter to the web such as an extrusion die, roll applicator, curtain applicator, and the like methods. The above description is but one example of how the dry particulate may be applied to the web. Alternatively, the dry particulate matter can be pre-applied to an already formed web by a mat vender so that the web can simply be unwound and used in existing forming equipment. In this case, it would be expected that excess particulate may be applied to the web to account for any loss of powder during shipment and/or unwinding.

With the preferred particulate matter as described above, the particulate generally does not adhere to, or only lightly adheres to, the web after application because it is loosely deposited to the inner surface thereof. If desired, the particulate (12) may be smoothed or spread over the inner surface of the fibrous mat using a smoother plate, doctor blade, nip, brush, roller, and the like. By one approach, the particulate is spread using a brush (40) shortly after the particulate is applied to the web and prior to application of the slurry at the slurry tank (20).

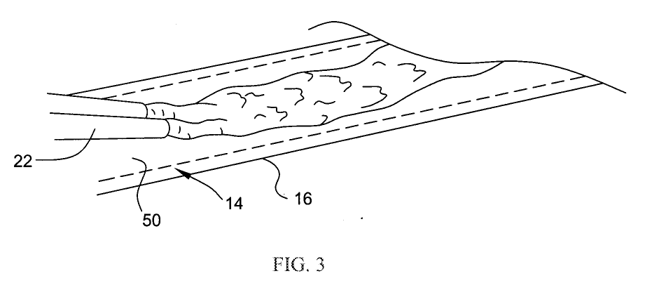

The particulate matter may be applied to only a portion of the fibrous web or may be applied to the entire width of the fibrous web. It has been discovered that bleed through of the gypsum slurry is most pronounced at the point where the slurry is first deposited onto the web prior to the forming head. Therefore, at a minimum, the dry particulate matter should be applied to a portion (50) of the inside surface (14) of the fibrous mat (16) that the gypsum slurry contacts prior to the forming head as schematically illustrated in FIG. 3. In this manner, the dry particulate material is positioned to hinder or block the penetration of slurry through the web pores where it is needed the most. Alternatively, if the dry particulate matter includes other additives to provide additional functional properties to the web, it is preferred that the dry powder be applied to the entire or substantially the entire width of the mat (16). Of course, these are only examples and the dry particulate matter can be applied to any width of the web as needed for a particular application.

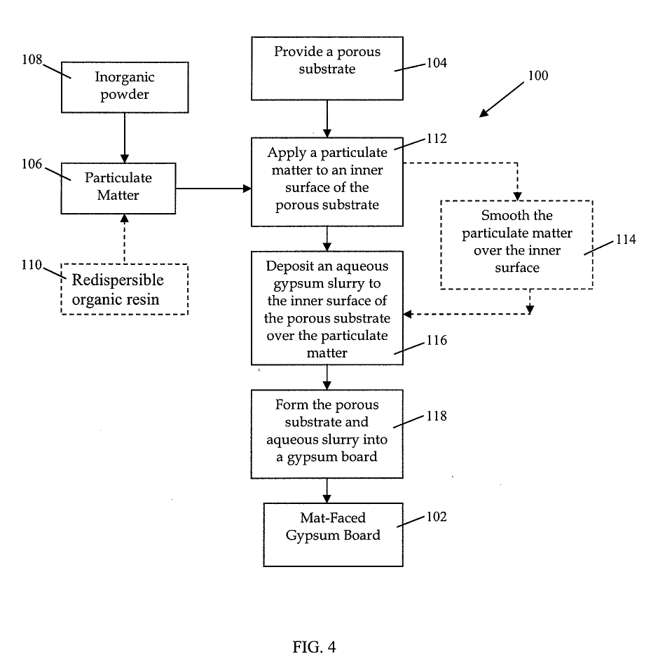

Referring to FIG. 4, an exemplary method (100) of forming a mat-faced gypsum board (102) with minimal and, preferably, no gypsum slurry bleed through is illustrated. The method (100) comprises first providing a porous substrate (104), such as a non-woven glass fiber mat. A particulate matter (106) is prepared that preferably includes an inorganic hydratable powder (108) and an optional redispersible organic resin (110). The particulate matter (106) is then applied (112) to an inner surface of the porous substrate (104). Optionally, the applied particulate matter (106) may be smoothed (114) over the substrate inner surface to obtain a more uniform application of the particulate matter. An amount of gypsum slurry is then deposited (116) onto the inner surface of the porous substrate over at least a portion of the particulate matter. The slurry deposited porous substrate is then formed (118) into a gypsum board.

The gypsum core can comprise, in addition to gypsum-based materials (e.g., water-soluble calcium sulfate anhydrite, calcium sulfate a-hemihydrate, calcium sulfate β-hemihydrate, natural, synthetic or chemically modified calcium sulfate hemihydrates, calcium sulfate dihydrate (“gypsum,” “set gypsum,” or “hydrated gypsum”), and mixtures thereof), any of a variety of additives. The additives can be any additives commonly used to produce gypsum board or cement board. Such additives include, without limitation, structural additives such as mineral wool, continuous or chopped glass fibers (also referred to as fiberglass), perlite, clay, vermiculite, calcium carbonate, polyester, and paper fiber, as well as chemical additives such as hydrophobic agents, foaming agents, fillers, accelerators, sugar, enhancing agents such as phosphates, phosphonates, borates and the like, retarders, binders (e.g., starch and latex), colorants, fungicides, biocides, and the like. Examples of the use of some of these and other additives are described, for instance, in U.S. Pat. Nos. 6,342,284, 6,632,550, 6,800,131, 5,643,510, 5,714,001, and 6,774,146, and U.S. Patent Publications 2004/0231916 A1, 2002/0045074 A1 and 2005/0019618 A1.

Advantages and embodiments of the mat-faced gypsum boards described herein are further illustrated by the following examples; however, the particular materials and amounts thereof recited in these examples, as well as other conditions and details, should not be construed to unduly limit this invention. All percentages are by weight unless otherwise indicated.

The following examples further illustrate the invention but, of course, should not be construed as in any way limiting its scope.

### EXAMPLE 1

This example demonstrates the application of a particulate matter to the inner surface of a porous substrate to form a powder faced substrate in accordance with the invention.

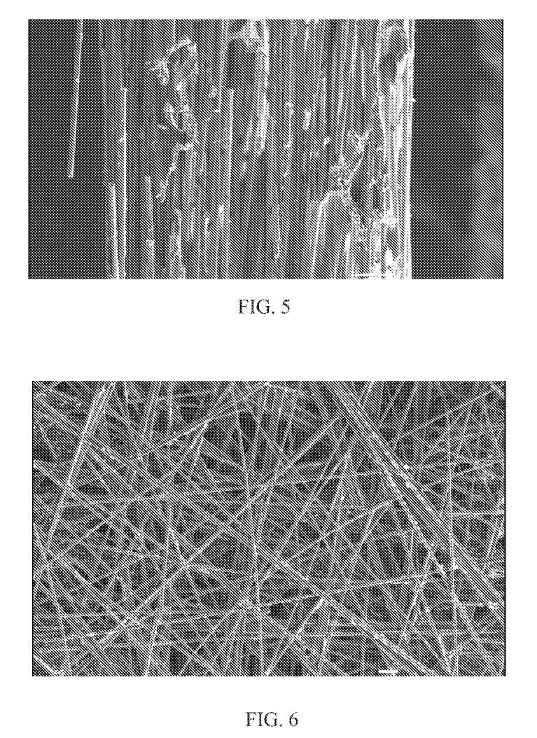

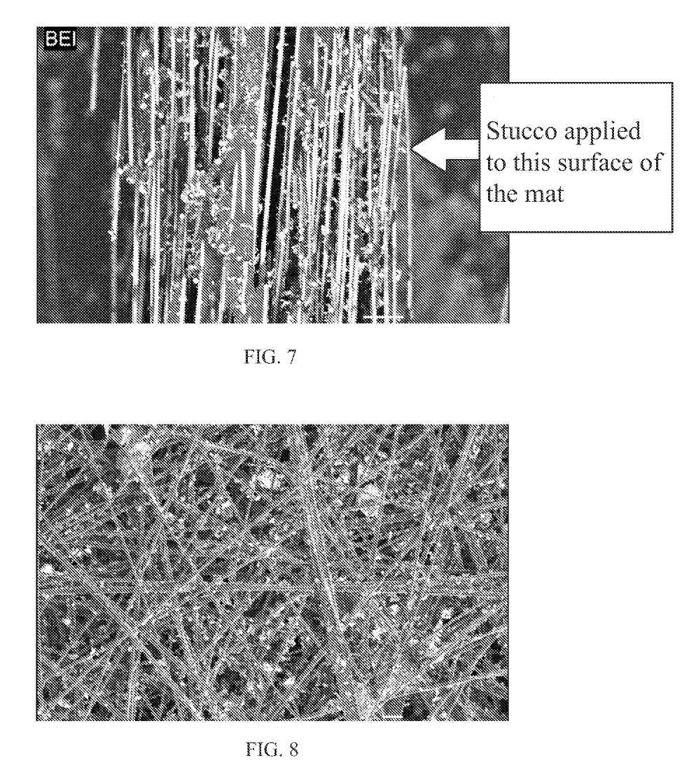

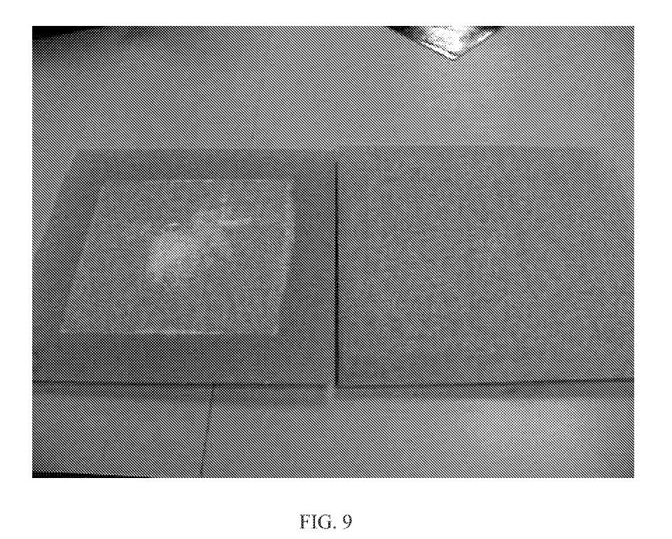

Dry stucco powder (USG, Chicago, Ill.) was shaken onto a surface of a glass fiber mat (Johns Manville, Denver, Colo.) at a rate of 20 lbs/1000 ft². This mat was fabricated from about 80 percent 16 micron diameter fibers and about 20 percent 11 microns diameter fibers and a basis weight of about 22 lbs/1000 ft². Even though the stucco was shaken onto the surface of the mat, SEM analysis using backscatter electron imaging to differentiate the stucco from the organic binder and glass fibers illustrates that the stucco penetrates partially into the interstices of the mat. FIGS. 5 and 6 are SEM images of the mat prior to application of the stucco, and FIGS. 7 and 8 are SEM images of the mat after shaking stucco on the surface thereof. FIGS. 5 and 7 illustrated cross-sections of the fibrous mat obtained by cutting the mat with a razor blade. In the image of FIG. 7, the stucco was applied to the right surface of the mat (i.e., the inner surface). The stucco material is the light particulate in the images of FIGS. 7 and 8 and shown extending partially into the thickness of the mat with the opposite surface essentially free of the particulate matter (cross section view of FIG. 7).

### EXAMPLE 2

This example demonstrates the effectiveness of a particulate matter applied to the inner surface of a porous substrate in preventing bleed through of a gypsum slurry.

A 2″×4″ cylinder of gypsum slurry was allowed to drop onto glass mats (Johns Manville) placed about 2″ below the cylinder. The amount of gypsum was deposited onto two identical sections of glass mat and each cast into a small board section. One glass mat had an amount of stucco powder spread across the surface of the mat prior to the slurry application at a rate of 20 lbs/1000 ft². The other glass mat did not have the dry stucco powder. Each board was cast from the same batch of slurry in succession and as quickly as possible to minimize any effects of setting or hydrating. As shown in FIG. 9, the glass mat having the stucco spread thereon (sample on right) did not exhibit bleed through of the gypsum while the glass mat without the stucco (sample on left) exhibited bleed through of the gypsum.

### EXAMPLE 3

This example demonstrates the preparation of a mat-faced gypsum board in accordance with the invention.

A dry particulate matter comprising 80 percent stucco (USG) and 20 percent of a redispersible powder polymer (vinyl acetate co-polymer, HD1501, Elotex AG, Switzerland) was applied at a rate of 20 lbs/1000 ft² to a glass mat to form a particulate filled glass mat. The glass mat included about 80 percent fibers with a 16 micron diameter and 20 percent fibers with an II micron diameter and a basis weight of about 22 lbs/1000 ft². A gypsum slurry was deposited onto the particulate filled mat and formed into a finished gypsum board. The board exhibited no gypsum bleed through and had an enhanced ability to receive a surface finish.

### EXAMPLE 4

This example demonstrates the preparation of a mat-faced gypsum board in accordance with the invention.

A dry particulate matter comprising 100 percent stucco (USG) was applied at a rate of 20 lbs/1000 ft² to a glass mat to form a particulate filled glass mat. The glass mat included about 80 percent fibers with a 16 micron diameter and 20 percent fibers with an II micron diameter and a basis weight of about 22 lbs/1000 ft². A gypsum slurry was deposited onto the particulate filled mat and formed into a finished gypsum board on a standard gypsum board manufacturing line. For the purposes of comparison, gypsum board was produced on the same manufacturing line using the same gypsum slurry and glass mat without applying the stucco powder to the mat. The outer surface of the mats was examined for each of the two types of boards. After manufacturing gypsum board comprising the glass mat with the applied particulate matter, the outer surface was clean with no significant gypsum slurry build-up, indicating that the particulate filled glass mat inhibited slurry bleed-through. By way of contrast, after manufacturing board without applying the particulate to the glass mat, the outer surface showed bleed through of the slurry.

It will be understood that various changes in the details, materials, and arrangements of parts and components which have been herein described and illustrated in order to explain the nature of the non-woven material and method of making thereof may be made by those skilled in the art within the principle and scope as expressed in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of forming a gypsum board, the method comprising:
(a) providing a porous substrate having an inner surface;
(b) applying a particulate matter to the inner surface of the porous substrate forming a powder faced substrate;
(c) depositing an aqueous gypsum slurry to the inner surface of the powder faced substrate over at least a portion of the applied particulate matter forming a slurry coated substrate wherein the particulate matter fills a portion of the pores in the porous substrate to hinder penetration of the gypsum slurry therethrough; and
(d) forming the slurry coated substrate into the gypsum board.

2. The method of claim 1, wherein the particulate matter comprises a hydratable powder and water from the aqueous gypsum slurry hydrates the hydratable powder.

3. The method of claim 2, wherein the hydratable powder comprises a gypsum-based particulate.

4. The method of claim 2, wherein the hydratable power comprises a filler selected from calcium carbonate, clay, and mixtures thereof.

5. The method of claim 2, wherein the hydratable powder comprises calcium sulfate hemihydrate.

6. The method of claim 1, wherein the particulate matter comprises a redispersible organic particulate selected from the group consisting of acrylics, polyvinyl alcohol, polyethylene glycol, polyvinyl chloride, vinyl acetate, copolymers thereof, and mixtures thereof.

7. The method of claim 6, wherein the particulate matter comprises about 1 to about 30 weight percent of the redispersible organic particulate.

8. The method of claim 1, wherein applying a particulate matter further comprises applying about 10 to about 40 lbs/1000 ft² of the particulate matter to the inner surface of the porous substrate.

9. The method of claim 1, wherein the porous substrate is a non-woven glass fiber mat.

10. The method of claim 9, wherein the non-woven glass fiber mat comprises about 70 to about 90 percent glass fibers having a diameter of about 10 to about 20 microns and about 10 to about 30 percent glass fibers having a smaller diameter of about 5 to about 15 microns with a basis weight of about 20 lbs/1000 ft² or greater.

11. The method of claim 9, wherein the non-woven glass fiber mat comprises about 80 percent glass fibers having a diameter of about 16 microns and about 20 percent glass fibers having a diameter of about 11 microns with a basis weight of about 20 lbs/1000 ft² or greater.

12. The method of claim 1, further comprising spreading the applied particulate matter over the inner surface of the porous substrate prior to depositing the aqueous gypsum slurry thereon.

13. The method of claim 1, wherein the particulate matter extends partially into the porous substrate from the inside surface thereof such that an outer surface of the porous substrate opposite the inner surface is essentially free of the particulate matter.

14. A mat-faced gypsum board comprising:
(a) a gypsum-based core;
(b) a fibrous mat having an inner surface facing at least one side of the gypsum-based core; and
(c) a hydrated particulate material on the inner surface of the fibrous mat and extending partially into the fibrous mat from the inner surface thereof;
wherein the hydrated particulate material is supplied independent of the gypsum-based core.

15. The mat-faced gypsum board of claim 14, wherein the hydrated particulate material comprises a gypsum-based particulate.

16. The method of claim 14, wherein the hydrated particulate comprises a filler selected from calcium carbonate, clay, and mixtures thereof.

17. The mat-faced gypsum board of claim 14, wherein the hydrated particulate material comprises calcium sulfate hemihydrate.

18. The mat-faced gypsum board of claim 14, wherein the hydrated particulate material comprises a redispersible organic particulate selected from the group consisting of acrylics, polyvinyl alcohol, polyethylene glycol, polyvinyl chloride, vinyl acetate, copolymers thereof, and mixtures thereof.

19. The mat-faced gypsum board of claim 18, wherein the hydrated particulate material comprises about 1 to about 30 weight percent of the redispersible organic particulate.

20. The mat-faced gypsum board of claim 14, wherein the mat-faced gypsum board comprises about 10 to about 40 lbs/1000 ft² of the hydrated particulate material.

21. The mat faced gypsum board of claim 14, wherein the fibrous mat comprises about 70 to about 90 percent glass fibers having a diameter of about 15 microns or greater and about 10 to about 30 percent glass fibers having a diameter of about 4-6 microns with a basis weight of about 20 lbs/1000 ft² or greater.

22. The mat-faced gypsum board of claim 14, wherein the fibrous mat further comprises a non-woven glass fiber mat including about 80 percent glass fibers having a diameter of about 16 microns and about 20 percent glass fibers having a diameter of about 11 microns with a basis weight of about 22 lbs/1000 ft² or greater.

23. The mat-faced gypsum board of claim 14, wherein an outer surface of the fibrous mat opposite the inner surface thereof is essentially free of the hydrated particulate matter.

24. A mat-faced gypsum board comprising:
(a) a gypsum-based core;
(b) a fibrous mat having an inner surface facing at least one side of the gypsum-based core; and
(c) a hydrated particulate material on the inner surface of the fibrous mat and extending partially into the fibrous mat from the inner surface thereof;
wherein the composition of the hydrated particulate material differs from the composition of the gypsum-based core.

25. The mat-faced gypsum board of claim 24, wherein the hydrated particulate material comprises a gypsum-based particulate.

26. The method of claim 24, wherein the hydrated particulate comprises a filler selected from calcium carbonate, clay, and mixtures thereof.

27. The mat-faced gypsum board of claim 24, wherein the hydrated particulate material comprises calcium sulfate hemihydrate.

28. The mat-faced gypsum board of claim 24, wherein the hydrated particulate material comprises a redispersible organic particulate selected from the group consisting of acrylics, polyvinyl alcohol, polyethylene glycol, polyvinyl chloride, vinyl acetate, copolymers thereof, and mixtures thereof.

29. The mat-faced gypsum board of claim 28, wherein the hydrated particulate material comprises about 1 to about 30 weight percent of the redispersible organic particulate.

30. The mat-faced gypsum board of claim 24, wherein the mat-faced gypsum board comprises about 10 to about 40 lbs/1000 ft² of the hydrated particulate material.

31. The mat faced gypsum board of claim 24, wherein the fibrous mat comprises about 70 to about 90 percent glass fibers having a diameter of about 15 microns or greater and about 10 to about 30 percent glass fibers having a diameter of about 4-6 microns with a basis weight of about 20 lbs/1000 ft² or greater.

32. The mat-faced gypsum board of claim 24, wherein the fibrous mat further comprises a non-woven glass fiber mat including about 80 percent glass fibers having a diameter of about 16 microns and about 20 percent glass fibers having a diameter of about 11 microns with a basis weight of about 22 lbs/1000 ft² or greater.

33. The mat-faced gypsum board of claim 24, wherein an outer surface of the fibrous mat opposite the inner surface thereof is essentially free of the hydrated particulate matter.
